(19) United States
(12) Patent Application Publication
(10) Pub. No.: US 2015/0029714 A1
(43) Pub. Date: Jan. 29, 2015

(54) METHOD AND SYSTEM FOR LIGHTING CONTROL

(71) Applicant: COMPULITE SYSTEMS (2000) LTD., Hod-Hasharon (IL)

(72) Inventor: Lior ZAR, Poryia Illit (IL)

(21) Appl. No.: 14/339,999

(22) Filed: Jul. 24, 2014

(30) Foreign Application Priority Data
Jul. 25, 2013 (IL) 227667

(51) Int. Cl. H05B 37/02

(52) U.S. Cl. CPC H05B 37/029
USPC 362/233

(57) ABSTRACT

A method and a system for lighting control, which utilize assigning to a specific fixture (lighting instrument) at least one virtual parameter convertible into one or more physical parameters of the fixture, for further controlling the fixture by controlling the mentioned at least one virtual parameter.

### FIELD OF THE INVENTION

The present invention relates to a technique for lighting control, more specifically for controlled lighting of a stage, an arena or the like at various performances (for example in theaters, concert halls, stadiums, circuses, etc.), where multiple lighting instruments are utilized.

### BACKGROUND OF THE INVENTION

Stage lighting applies to the production of theatre, dance, opera and other performance arts.

The four main qualities or properties of lighting, which are expected to be achieved by a lighting designer, are intensity, color, shape and focus of one or more lighting instruments. Let them be called general parameters or characteristics.

Intensity of a luminaire (i.e., lighting instrument, fixture, projector, lamp, light) depends on a number of factors including its lamp power, the design of the instrument and its efficiency, optical obstructions such as color gels or mechanical filters, the distance to the area to be lit, and also depends on some additional factors.

Color of a light is determined by its lamp color, the color of any gels in the optical path, the lamp's power level, and the color of the material it lights. In the simplest case (so-called Fixed Color System), a single gel is inserted into the optical path to produce light of the same color. For example, a blue gel is used to create blue light.

Custom colors may be obtained by means of a system of subtractive color mixing called CMY, by inserting combinations of Cyan, Magenta and Yellow dichroic filters into the optical path of the lighting fixture. There is an alternative, additive system RGB (Red, Green, Blue) known for creating customized color light. For example, LED fixtures usually create color through the additive color mixing with red, green, and blue LEDs at different intensities.

Shape or Pattern (sometimes called Direction) refers to the shape, quality and evenness/brightness of a lamp's output. The pattern of light in the lamp is largely determined by three factors: reflector and lens assembly, focus and, lastly, a gobo or break up patterns used with the lamp.

Focus is a term used to describe where a lighting instrument is pointed, and is usually associated with the instrument's position and hanging. The final focus should place the “hot spot” of the beam at the actor's head level when standing at the center of the instrument's assigned “focus area” on the stage. Position refers to the location of an instrument in the theater's fly system or on permanent pipes in front-of-house locations. Hanging is the act of placing the instrument in its assigned position.

The above-mentioned four general parameters (Intensity, Color, Shape, Focus) should usually be dynamic and controllable during a performance, since variation in these parameters is used in achieving the goals of lighting.

The problem is that, being the desired general parameters of lighting, the above four ones usually cannot be achieved/controlled by directly controlling real world (physical) parameters of existing fixtures. The reason is that the physical parameters of fixtures, defined by their manufacturers, are a) different from the above-discussed general parameters, and b) different for different fixtures.

For example, to control color, physical parameters of a specific fixture may comprise so-called Red, Green and Blue attributes, each controlled by a control succession of binary DMX words (0-255 bits) or by percentage between 0-100%.

To control focus of a specific fixture, one may use physical parameters such as Pan and Tilt, expressed by degrees (say, between 0-540 or 0-270 degrees). Pan and Tilt may be controlled by the similar DMX binary words or by percentage between 0-100%.

To control shape/pattern, each specific fixture may have its own limited collection of selectable gobo figures which also constitute physical parameters/attributes.

For automatically controlling movable lights, modern systems of lighting control utilize desks/consoles with underlying software. Such control consoles are manufactured by a variety of companies and usually have the common drawback being in that the lighting control is not standardized.

The above problem stems from the fact that various existing fixtures have different properties and parameters, and thus behave differently in response to control. If a particular control console is adapted to coordinate a specific group of fixtures, that same console may appear to be useless or hardly adaptable for controlling a fixture newly installed in that group, not speaking about a totally different group of fixtures at a different stage. In such cases, operators of the lighting may be forced to perform from the scratch all the preparation work for one or more performances.

Due to absence of any standardized method for control of intelligent lighting, some attempts were undertaken to consolidate various ways in which hundreds of types of intelligent fixtures are controlled.

The Horizon Control company developed their own approach of how to unify control of various specific fixtures to achieve/control the general lighting parameters.

The Horizon's (horizoncontrol.com) White Paper “The Abstract Control Model” [© Horizon Control Inc. 2005], proposed the idea of a so-called abstract interface and called it Abstract Control Model (ACM).

One of the Horizon's ideas was to consolidate the control under the single abstract interface comfortable for the user. As proposed by Horizon, the abstract interface can be formed by integrating knowledge on different fixtures and their physical parameters/attributes into software of the lighting desk/console, so that specific details (such as how parameters Pan or Tilt are controlled for one device vs. another device) are hidden from the operator. This frees the operators to think in terms of what physical parameter they want to achieve (e.g. “Pan 30 degrees clockwise”) instead of how it should be achieved for any given fixture (e.g. instead of sending a control sequence of a kind: DMX value 137 down channel 23, etc.).

For example, special features of lighting, which a light designer wishes to achieve, may be reached using such commands/cues or ACM control “words”, as the following: 15 degrees of Pan; Rotate counter clockwise at 6 rpm; Strobe at 9 hertz; Thrust the shutter into the aperture of the fixture half way, etc. During the show time, these “words” (commands) related to physical parameters need to be converted into control sequences that the specified lighting fixtures can use. The Abstract Control Model (ACM) should ensure that the conversion is figured out each and every time “GO” is pressed.

The abstract interface should be capable of coping with the typical problem of replacing a fixture with one from a different vendor that has different control sequences, and theoretically no changes would be needed from the side of the control operator.

Horizon also proposed means to control colors via the Abstract Control Model (ACM), by choosing and combining any of available color spaces. The basic color spaces used by many known consoles are CMY and RGB. The ACM proposed by Horizon also allows choosing and crossfading other color spaces including such as HSV (Hue Saturation Value) and HSL (Hue Saturation Luminance).

To summarize the Horizon's idea of Abstract Control Model (ACM), the ACM allows programming physical parameters (Pan, Tilt, Cyan, Magenta, Yellow, Red, Green, Blue, etc.) of specific fixtures, instead of programming corresponding control sequences (DMX values etc.) for these specific fixtures, and the board/console does the rest.

From the technical perspective, ACM relies on a large library of fixture definitions for various types thereof, with all parameters and control sequences (controls) predefined and mapped out in advance. The operator then selects the fixture(s) and enters the physical parameters of the fixture(s) to be controlled, so that the board/console converts those for every fixture he has got patched, and sends out the appropriate controls.

The major challenge of ACM is therefore assembling an accurate and comprehensive library of fixtures, to control them via ACM using physical parameters.

However, in practice ACM does not effectively perform its declared functions due to a simple reason that, when controlling physical parameters such as Red, Pan, Tilt, etc., initial conditions and initial positions of different fixtures usually cannot be taken into account by the single abstract control model (interface).

There is yet another issue proposed in the Horizon paper, namely—exposing and utilizing Phantom abstract attributes, namely—utilizing an Intensity attribute which is not allotted as is by fixture manufacturers. The reason to do it was as follows. Traditionally, in RGB LED fixtures, the only controls the user can adjust are Red, Green and Blue. To bring the fixture to maximum intensity or to blackout it, the operator needs to adjust three parameters rather than one.

To bring the fixture back to the previous intensity condition, the three parameters must be adjusted again, or should be somehow returned to the RGB values from the preceding cue (command) to restore them. The phantom attribute “Intensity” proposed by Horizon was supposed to resolve that problem without intervention of the operator.

Presently, the use of phantom parameters in modern lighting consoles/systems if exists at all, is limited to the Intensity (I) which is considered a kind of an ACM dimmer.

Some additional color spaces such as HSL (Hue Saturation Luminance) or HSV (Hue Saturation Value) were proposed by Horizon for cross-fading of existing real world color spaces. However, even if proposed as an option for use in a control console, such color spaces are usually not acknowledged for use by various specific fixtures and therefore remain theoretical.

### OBJECT AND SUMMARY OF THE INVENTION

It is therefore the object of the present invention to provide a technique for lighting control, namely a method, a system such as a control console and a software product, which would overcome the above-mentioned drawbacks.

According to a first aspect of the invention, the above object can be achieved by a method for lighting control the method comprises assigning to a specific lighting instrument, such as a fixture, at least one virtual parameter convertible into one or more physical parameters of the fixture, for controlling the fixture by controlling said at least one virtual parameter.

The method may then comprise a step of controlling said fixture by controlling said at least one virtual parameter. Further, the control may be performed in real time.

The method may be applied for controlling a group of fixtures including at least one said fixture.

The mentioned at least one virtual parameter may comprise at least one of the following:
a phantom parameter not existing among physical parameters of any fixture (not allotted by any fixture manufacturer);
a physical parameter not existing among physical parameters of said specific fixture (not allotted by its manufacturer), while existing among physical parameters of a different fixture.

The above-mentioned phantom parameter not existing among physical parameters of any fixture may be selected from the following non-exhaustive list:
“HSI” being Hue, Saturation, Intensity;
“X,Y,Z” being coordinates of the fixture's “hit point”,
“Red all”, “Green all”, “Blue all”,
“Cyan all”, “Magenta all”, “Yellow all”,
“general/virtual Gobo”.

More specifically, the method may be applied for controlling a group of fixtures including at least one said fixture, the method comprises providing individual interfaces for respective fixtures of the group, wherein each of the individual interfaces

allows controlling said at least one virtual parameter and
provides one or more conversion functions for converting values of said at least one virtual parameter into values of physical parameters of the corresponding fixture,
thereby enabling control of the physical parameters of said group of fixtures by said at least one virtual parameter.

In the method for controlling the group (a plurality) of fixtures, each specific fixture of the plurality has a basic set of physical parameters allotted by the manufacturer of the specific fixture, and the step of providing the individual interfaces comprises

representing each specific fixture of said group by an individual interface (I/F) enabling control of a combined set of parameters, wherein said combined set for a specific fixture comprises:
the basic set of physical parameters of the specific fixture,
an additional set including said at least one virtual parameter, along with respective one or more conversion functions, for converting each of the at least one virtual parameters into one or more physical parameters of the specific fixture,
   the method thereby ensuring that each of said individual interfaces is capable of receiving control instructions to said at least one virtual parameter, converting said control instructions into control commands to one or more of said physical parameters of the individual interface, for further controlling the corresponding fixture using said control commands.

The method defined above is actually the method of preparing means (such as a control console) for further lighting control, wherein the lighting control is to be performed by controlling/affecting the virtual parameters, in practice.

As mentioned, the method may therefore further comprise controlling the (at least one) fixture by affecting said at least one virtual parameter. It may be performed via the respective individual interface of the fixture.

Preferably, the step of controlling one or more of the fixtures (say, during a performance/show, preparation to a show or during any adjustment work) is executed by applying successions of values of said at least one virtual parameter to their respective individual interfaces.

The individual interfaces may be hardware/software or software blocks, such as files and/or groups of programs.

Preferably, the method comprises a step of forming said one or more individual interfaces (I/F) from available data bases comprising information on real (physical) parameters of specific fixtures. Preferably, a number of basic I/F is preliminarily provided, but the user may create additional I/F when needed, by using an internal data base and/or additional data bases if required. The internal data base formed for the method (preferably, in the control console) may be called inventory data base.

The method enables control of said fixtures by providing, in one or another manner, translation of control commands related to the physical parameters (or actually, translation of values of the physical parameters) of specific features into control sequences acceptable by the specific fixtures.

The method may comprise providing the individual interfaces with additional conversion functions for translating the control commands related to said physical parameters into control sequences (such as DMX binary words etc.), required to operate said specific fixtures.

Alternatively, the method may comprise providing and using an abstract interface, for example in the form of so-called abstract control model ACM similar to that proposed by Horizon©, for said translation of physical parameters values obtained from the individual interfaces, into control sequences. 5

The method also comprises a step of adjusting the individual interfaces to initial conditions and location of their corresponding fixtures.

It is one of important advantages of the invention (that each of the individual interfaces is adaptable to initial conditions/location of the corresponding fixture). It may relate both to the exact coordinates of the fixture related to the stage, to its initial pan/tilt and to its individual properties such as real condition of its components, etc. For example, in order to achieve a specific required value of a virtual parameter such as “RED all”, “Intensity”, etc., one fixture allows activating quite a wide area of its colored gel sticks or lenses by a predetermined control sequence, while another fixture requires activation of a very narrow portion thereof (due to drying, some defects, etc). Adjustment of the conversion function in the individual interface allows easily resolving such problems. Adjustment of the individual I/F to exact location of the fixture may be performed, for example, by utilizing a so-called function of four point calibration incorporated in the individual or central I/F. This or another technique allows calculating the size of the stage and determining the fixtures coordinates, based on measuring the angles by a light beam.

It should be noted that in case a user prefers using physical parameters for control, the proposed technique allows it be done via the same individual interface and by utilizing the combined set of parameters which intrinsically comprises physical parameters of the fixture.

In a further version of the method, at least one of the conversion functions of the individual interface may be additionally provided with a capability to forward values of the physical parameters, obtained from given values of the virtual parameters, toward relevant elements of the specific fixture in a predetermined order in space and time.

In a specific version of the method, the Virtual Gobo parameter is based on utilizing a combined Gobo data base comprising a plurality of gobo patterns and being categorized so as to enable a user/a program to select a desired gobo pattern from it (thereby selecting a virtual gobo pattern), while the respective, gobo conversion function in the individual interface is adapted to convert thus selected gobo pattern into the closest gobo pattern allotted in the corresponding fixture.

It goes without saying that the plurality of fixtures may either comprise fixtures of the same type, or different fixtures.

Preferably, the method comprises providing all fixtures of the plurality with a unified combined set of parameters, so that to enable controlling all said fixtures by affecting similar common parameters of the unified combined set.

The method may further comprise providing a central interface (in a control system, computer, console or the like), adapted to allow control by a user of one or more common virtual parameters for the plurality of fixtures, and ensuring that said central interface is in communication with the individual interfaces of the fixtures.

Further, the method may comprise performing any lighting performances or successions, generally called light effects, on one or more of the fixtures, by programming said effects based on control of the virtual parameters of said fixture(s). In other words, any lighting effects may be implemented by controlling the virtual parameter(s) of one or more of fixtures of the plurality.

For example, a group of virtual parameters HSI (Hue, Saturation, Intensity) may be used as a base for programming various light effects.

Further, the method may comprise creating a library of the light effects written down in the virtual parameter(s).

The principle difference of the proposed inventive method from the Horizon's idea of ACM is in that ACM controls fixtures by physical parameters, while the invention controls fixtures by virtual parameters.

More specifically, ACM constitutes a single control interface of physical parameters, and performs control of the fixtures via the single interface by physical parameters, while the Inventors propose something opposite and new: using individual control interfaces for each fixture, wherein each of the individual control interfaces comprises virtual parameter(s) not allotted for that specific fixture but provided with conversion function(s) for conversion the virtual parameters into physical parameter(s) of the fixture. Therefore, according to the invention, the fixtures (be they uniform or different) can be controlled by controlling virtual parameters provided in their respective interfaces.

To control the virtual parameters, the method actually comprises a preliminary step of programming behavior of fixture(s) by programming virtual parameters of the fixture(s), to obtain a program/file comprising succession of values of virtual parameters for one or more fixtures.

In one specific case, such a file may be a file of a light effect. In another example, such a file may be a lighting program of a complete performance.

Therefore, whenever a file of the obtained succession of values of virtual parameters is stored (say, in the control console), the file (and consequently the console) may be further used at any other stage and/or with any other group of fixtures, for example comprising at least one replaced lamp. The program based on control of virtual parameters will be suitable for other fixtures, provided that they will have their individual interfaces on the console; it is possible that some calibration may be required to determine initial conditions/location of the fixtures.

The method may therefore further include a calibration step comprising checking virtual parameters' values, so as to (even manually) adjust thereof to the physical parameters of the corresponding new/modified/replaced fixtures. The calibration step may be performed both before and after the programming stage.

Indeed, let there is a performance for which a program of lighting is known in advance and programmed for an original set of fixtures of a specific manufacturer. Let then the performance is moved to another concert hall and there is a different set of projectors/fixtures, of a different manufacturer.

If the program is written down for DMX parameters or even for physical parameters of the original set of fixtures, it will be non-applicable for the new stage.

In contrast with that, the method and the library/data base proposed by the Inventor allows calibrating the program in minutes, maximally in hours (depending on the number of fixtures at the new place) for different physical parameters of different projectors/fixtures of a different manufacturer, whenever these projectors are presented by their individual interfaces comprising virtual parameters.

In this case, the file of the lighting performance, may be

a) adjusted by calibration of the virtual parameters' file to the new conditions (and not by recalculating the whole performance);
b) in case the previous program is written in real parameters (say, if such a file exists at the new place), the method may allow at least partial conversion thereof into virtual parameters using some of the conversion functions of one or more of the individual interfaces.

The adjusted virtual parameters file may be then stored (in the console, in the library) for that new performance at that new place.

The calibrated and stored succession of the virtual parameters will be translated to the other/new/modified real parameters in real time during the performance.

The method may comprise, for example, storing a succession of values of virtual parameters HSI obtained in real time for a group of fixtures (per fixture) in the specific performance, in order to allow further re-storing of the control sequence either for the same fixture, or to any other fixture replacing said specific fixture.

In this manner, a specific real parameter such as R, G or B of a fixture of a specific manufacturer may be finally expressed as being composed by n %(H)+m %(S)+k %(I) of the virtual values H, S, I. The same real parameter of another fixture, of the same or another manufacturer company may have a different combination of percentages in the above equation.

Therefore, when a file of the obtained succession of values of virtual parameters is stored in the control console, the console may be further used at any other place/stage and/or with any other group of fixtures, for example comprising at least one replaced lamp.

The calibration (re-calculation) step may comprise:
Associating the pre-programmed fixtures with other, corresponding fixtures at the new stage/in the new set;
Introducing data about real parameters of the corresponding fixtures into the inventory data base and/or into the individual interface, instead of those of the pre-programmed fixtures.

In other words, the calibration (recalculation) step may comprise, actually, replacing the individual interface of the “old” fixture with the individual interface of the “new” fixture.

In practice, conversion of the virtual parameters' values into physical parameters' values is performed in real time (say, 44 times a second when sending commands from the console to a specific fixture). Still, any specific set of recalculated virtual parameters (which is suitable for that specific stage, for example) is preferably stored in the console in the form of virtual parameters, since storage of physical parameters (as was done in the prior art) makes little sense. Real parameters may always be obtained for the existing and any other plurality of fixtures or stage and in real time, from the existing or the recalculated successions of virtual parameters and be immediately sent to the suitable fixtures in the form of physical parameters or control sequences (DMX commands).

Preferably, any program for control of color, focus, effects of lighting instruments may initially be expressed in the values of the proposed virtual parameters. If done this way, any adjustment for real conditions may be performed in one step.

However, all necessary calculations or re-calculations may be performed in the proposed computerized control console/software product according to the invention, no matter how the lighting program/calculation was done for the fixtures at the beginning.

The method may comprise a step (supported by a suitable software means) for recalculating a lighting program made in physical parameters into that made in virtual parameters. Still, if one or more fixtures are changed, a new adjustment will be required.

In some cases, the individual interfaces I/F may perform reverse calculation of the control commands from the physical parameters into the virtual one, but there are some restrictions. Some conversion functions, for example “All Red”, may be so-called “one to many” in one fixture interface, and “one to one” in another. Some conversion functions are fuzzy like the virtual Gobo, so that a physical gobo of one fixture cannot be converted into a virtual gobo which would give the same physical gobo at any other fixture.

According to a second aspect of the invention, there is provided a system for controlling a plurality of fixtures according to the proposed method.

For example, there is proposed a system (for example, a control console) for controlling a group/plurality of fixtures including at least one fixture, the system comprises one or more control inputs for controlling one or more virtual parameters of at least one of said fixtures by a user or a program.

The definition and examples of the virtual parameter(s) were given above.

The control input(s) may be implemented in the form of: a graphical user interface (GUI), a touch screen, control input(s) to individual interface(s) of said fixture(s), control input(s) to playback units, etc.

The system may further comprise a central processing unit and data bases suitable for forming and further using individual interfaces of the fixtures, each of said individual interfaces providing said at least one controllable virtual parameter, said individual interfaces being in control communication with said control inputs at one end (i.e. being controlled by the control inputs), and with said fixtures at another end (i.e., controlling the fixtures).

The virtual parameter(s) may be controlled by a user/a program either directly, by using the control inputs at each specific individual interface, or for example via playback units usually existing in any control console, and/or via a central interface provided for communication with the individual interfaces of the fixtures.

Still further and according to a third aspect of the invention, there is provided a to software product comprising computer implementable instructions and/or data for carrying out the above-described method, said software product being stored on an appropriate computer readable storage medium so that the software is capable of enabling operations of said method when used in a computerized system.

Consequently, there is also provided a computer readable storage medium such as a server, a hard disc or any other stationary or removable medium accommodating the software product or portion thereof, intended for implementing one or more operations of the inventive method.

The invention will be described in further details as the description proceeds.

### BRIEF DESCRIPTION OF THE DRAWINGS

The invention will be further described with reference to the following non-limiting drawings, in which:

FIG. 1 (prior art) is a block diagram schematically illustrating how the presently known systems of lighting control are organized.

FIG. 2 is a block diagram schematically showing the proposed individual interface for a lighting fixture, adapted for controlling the fixture by virtual parameters.

FIG. 3a schematically depicts physical areas of a specific fixture which may be separately controlled by a virtual parameter of the type Red All, using one or more conversion functions.

FIG. 3b schematically depicts the order of forwarding values of physical parameters, obtained by the conversion functions, to various physical areas of the fixture shown in FIG. 3a.

FIG. 4 is a schematic block diagram illustrating one embodiment of the proposed system, in the form of a control console for lighting control by virtual parameters, comprising a central interface and a number of individual interfaces, each in communication with the central interface and the respective fixtures.

FIG. 5a is a simplified general flow chart of the proposed method.

FIGS. 5b-5e schematically show specific portions of the general flow chart of FIG. 5a.

### DETAILED DESCRIPTION OF THE PREFERRED EMBODIMENTS

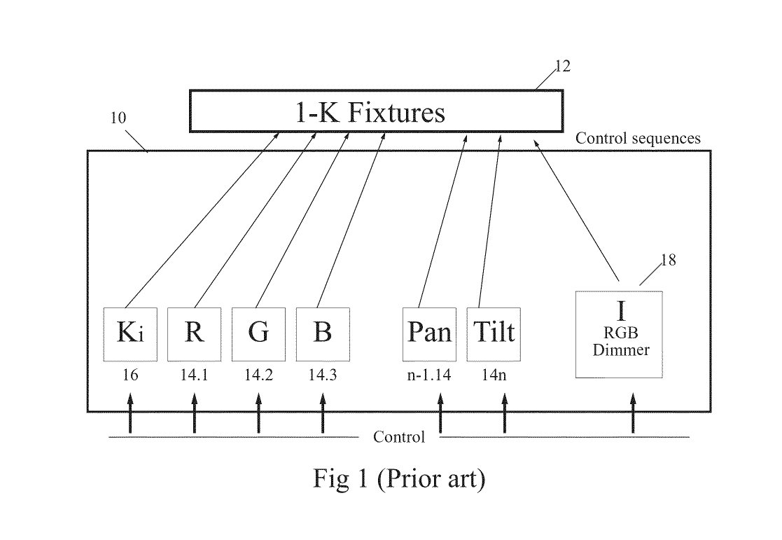

FIG. 1 (prior art) schematically illustrates an example of a real control console 10 for controlling a plurality of fixtures 12 (“K” fixtures are controlled in this example). The console 10 is provided with “n” control inputs, schematically 5 shown as blocks 14.1 to 14.n, for controlling physical parameters allotted to the fixtures 12 to be controlled.

The physical parameters may be such as R, G, B for controlling colors according to the color space RGB which is often utilized in modern fixtures, Pan, Tilt, etc. Box 16 schematically illustrates a possibility to select the fixture to be controlled by the parameters 14.1-14.n. The control may be performed by a user/operator, by applying suitable control commands to boxes 14 of the physical parameters and to box 16.

The console shown in FIG. 1 further comprises a so-called “RGB” dimmer 18 actually controlling the intensity parameter (I). It is called dimmer since it can be controlled directly by a user. Control applied to any of the physical parameters as well as to the dimmer 18 is then translated into control sequences by the console.

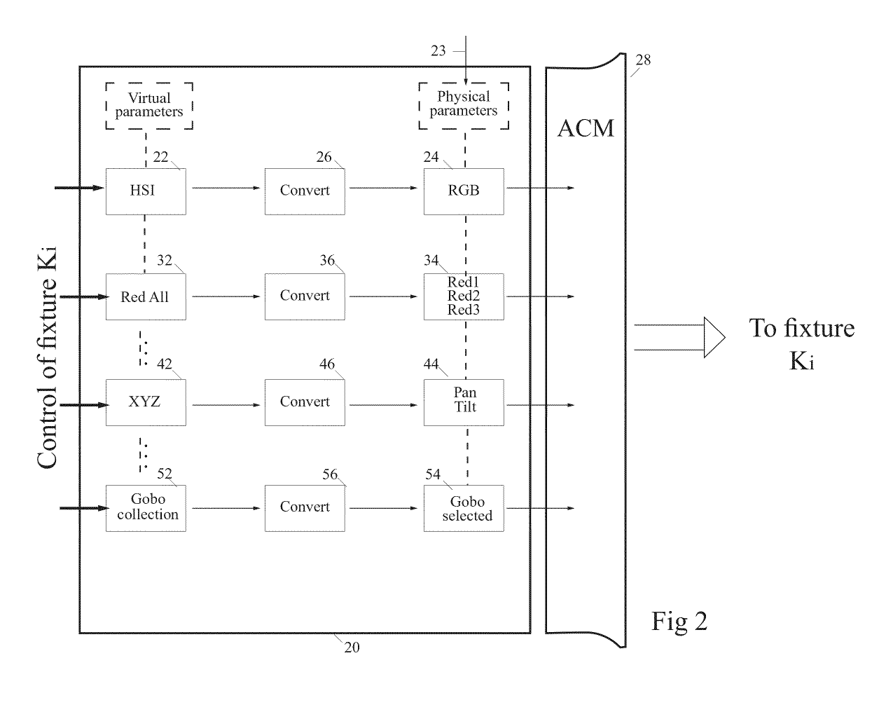

FIG. 2 schematically illustrates the concept of the invention in the terms of a system.

Let each specific fixture kᵢ among those to be controlled is provided with its individual interface (I/F) 20, which allows controlling the fixture by affecting some virtual parameters which are not allotted for the fixture kᵢ by its manufacturer, but would be convenient for the user.

Let the I/F 20 comprises control inputs to a number of parameters, some of which are virtual parameters (shown by boxes 22, 32, 42, 52) and some are physical parameters 24, 34, 44 55 One schematic optional control input arrow 23 is shown in this drawing for one or more physical parameters.

The control inputs of the interface 20 may be activated directly or via an optional central interface.

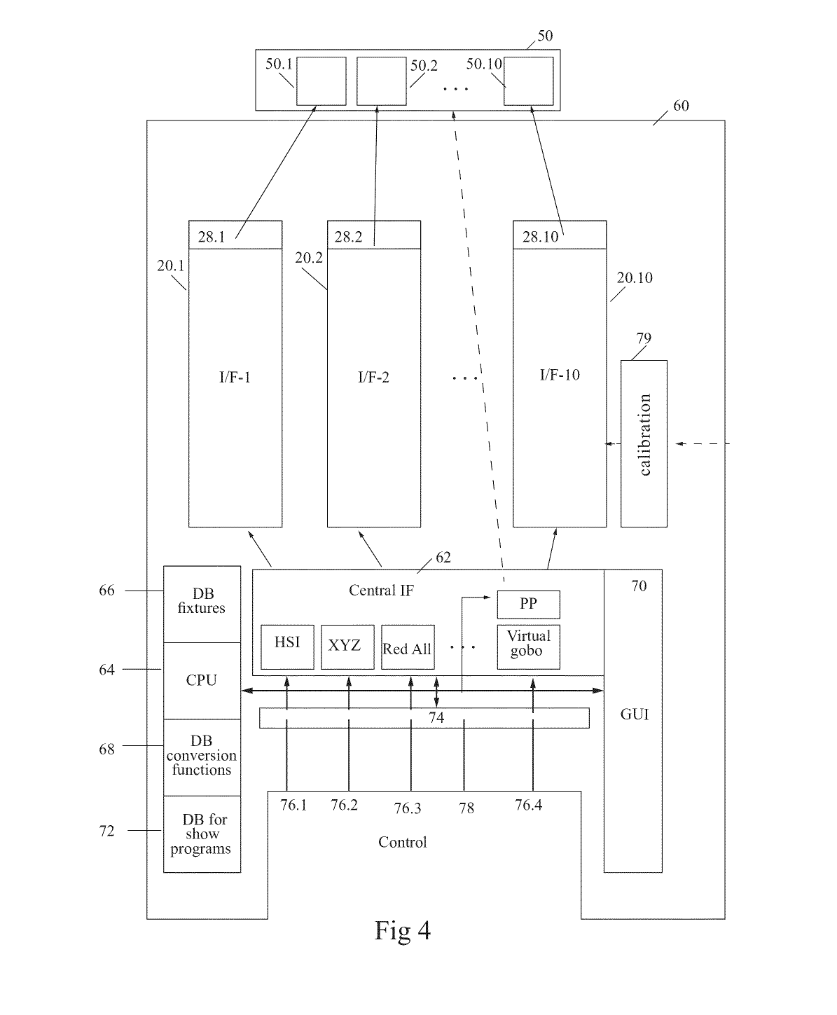

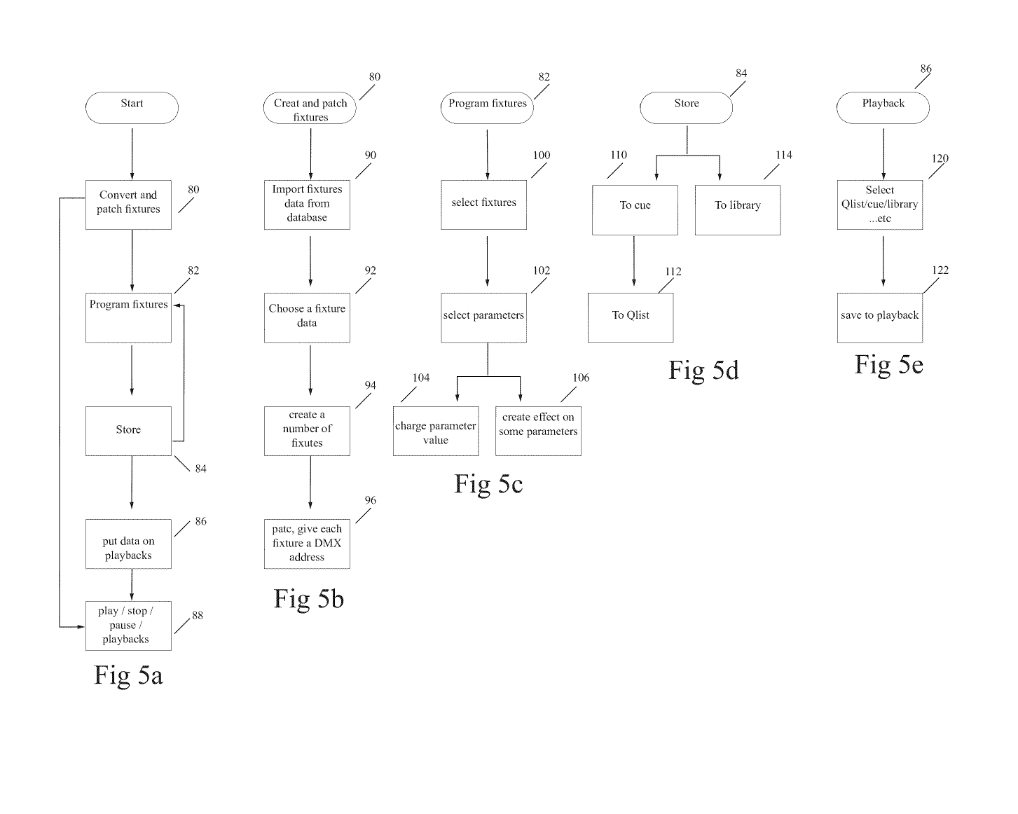

The control may be applied by a user/a program (for example, through playbacks, see FIGS. 4 and 5).

Let the fixture kᵢ has physical parameters of the color space R G B allotted by the manufacturer and schematically shown as box 24 in the Interface 20.

However, in order to allow controlling this fixture by a universal color space HSI formed by virtual parameters Hue, Saturation and Intensity, the I/F 20 of the fixture kᵢ is provided with a control block of the virtual color space/parameter HSI (box 22).

In the interface 20, physical parameters RGB are obtained from virtual parameters HSI by using a group of conversion functions, schematically shown as box 26.

The HSI space is mathematically convertible into at least such conventional color spaces as CMY and RGB (by ratios, coefficients, equations or the like); at least those of them relevant to RGB will be stored in the box 26.

In this manner, a specific real parameter such as R, G or B of a fixture of a specific manufacturer may be finally expressed as being composed by n %(H)+m %(S)+k %(I) of the virtual values H, S, I. The same real parameter of another fixture, of the same or another manufacturer company may have a different combination of percentages in the above equation.

In practice, the user sets values H, S, I and the software of the I/F 20 converts the values in real time into RGB values relevant for this specific fixture kᵢ, which may further be sent to the fixture kᵢ, possibly via an optional abstract interface 28 which converts the control commands into control sequences directly applicable to the fixture kᵢ.

Alternatively, each of the interfaces (and the interface 20 particularly) may be provided with its own converter of control commands related to its physical parameters into control sequences.

According to the invention, interface 20 may further enable control via virtual parameters Red All, Green All, Blue All, Cyan All, Magenta All, and Yellow All (only Red All is shown, presented by the box 32), which are intended to allow simultaneous control of a number of lighting areas within the same fixture. Though existed before, such physical commands as Red All were never used as virtual parameters and were never introduced in an individual interface for controlling a specific fixture.

Different lighting areas in a fixture are usually controlled separately by separate physical parameters such as red1, red2, red3, which are developed specifically for each specific fixture having its specific number of these areas. The proposed virtual parameters of the kind “Red All” are universal for any number of lighting areas, and extremely useful in cases when simultaneous action of such areas is required.

Let the user sets a value of the virtual parameter “Red All” to control the red color of fixture kᵢ. The software of the conversion function 36 converts the control value into red1, red2, red3 . . . redn values that may be applied to the respective areas of the fixture kᵢ (directly or via the block 28).

XYZ (box 42) is a system of virtual parameters for determining coordinates in space in quite a comfortable and natural manner. If provided in the I/F 20, the user may set values of these coordinates in order to control the light spot of the fixture kᵢ. on the stage, though in reality the fixture kᵢ is controlled by physical parameters Pan and Tilt (box 44). The individual interface I/F will also have to accommodate a conversion block 46 for real time translating values of XYZ into values of Pan and Tilt, taking into account the initial/current location of the fixture kᵢ. Actually, block 46 may incorporate a function for determining current “location” (current hit point of the beam) of the fixture kᵢ. (and preferably, being in communication with a separately standing hardware device, not shown). The values of Pan and Tilt may be sent to the fixture kᵢ directly or via the block 28.

GOBO (box 52) is a virtual parameter proposed by the Inventor. The box 52 may comprise a searchable data base with a collection of Gobo patterns useful for performances and divided into categories, kinds, types, etc. (The collection may comprise different shapes such as waves, lines, stars, etc.). The user may 5 set a control value, for example by stating a combination of category/kind/type of the desired Gobo. We keep in mind that the fixture kᵢ is provided with its own set of Gobo shapes, which can be considered the fixture's physical parameters. The software of box 56, in real time, converts the control value into the closest Gobo pattern available in the fixture kᵢ and forwards the command towards the fixture k₁, to select that closest Gobo pattern.

If all the lighting instruments (fixtures) to be controlled are provided with their individual interfaces similar to 20, and if all the interfaces have uniform virtual parameters, the fixtures can be controlled in a uniform manner. For example, colors of all the fixtures can be controlled by controlling values of the parameters Hue, Saturation and Intensity of the virtual color space HSI in real time. It can be done by preliminarily obtaining a succession of values of the virtual parameters for each specific fixture in a specific performance (i.e., by preliminary programming the show).

In practice, for each of the fixtures, and for each real parameter thereof, it should be ensured that a transition rule or table exists (in the corresponding box 26, 36, 46, 56 of the suitable interface), stating which values of which virtual parameters, should be selected to achieve one or more specific values of a specific physical parameter.

For creating such individual interfaces:
a) detailed inventory data base(s) of existing physical parameters of available fixtures produced by various companies should be preliminarily built, and
b) conversion functions for each of the fixtures with respect to a suitable virtual parameter should be allocated or developed and also stored in a suitable data base of conversion functions.

If such is provided, and the individual interfaces 20 are built (some of them may be built in advance as default ones, and some of them may be created by the user if required), they will enable conversion of the succession of values of a virtual parameter (for example HSI, or virtual Gobo) into values of existing physical parameters (for example, of any conventional color space or a particular gobo) of a specific lighting instrument, in real time.

Values of the virtual parameters, programmed for each particular fixture for a specific show, may be stored in the control console's memory and further fed to boxes 22, 32, 42, 52, etc. of suitable individual interfaces.

During the performance, in real time, the programmed values of the virtual parameters will be converted (boxes 26, 36, 46, 56) into values of real parameters (boxes 24, 34, 44, 54) of each of the fixtures participating in the performance, and corresponding control sequences will be sent to the suitable fixtures.

Moreover, it should be noted that the conversion functions 26, 36, 46, 56 downloaded for each of the interfaces 20 from the data base of conversion functions, may (and will) be adjusted to their corresponding specific fixtures by calibration. This fact allows programming the fixtures control uniformly, and further controlling the fixtures by uniform values of the virtual parameters.

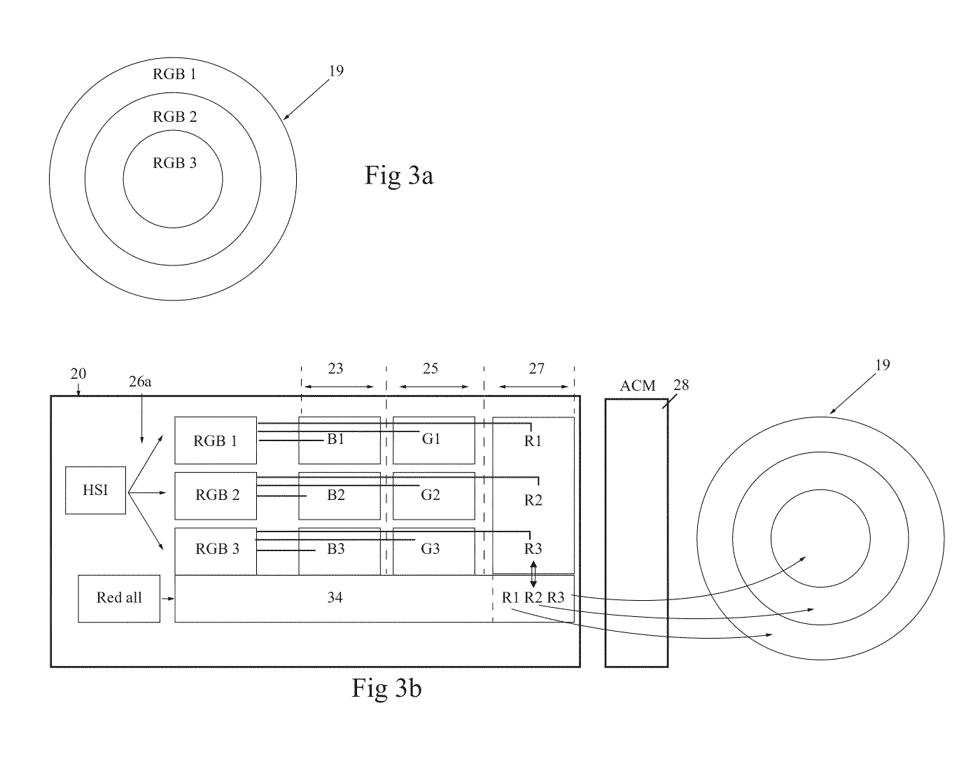

FIGS. 3a, 3b, schematically illustrate how the virtual parameter HSI and a virtual parameter of the type Red All may be used for controlling a specific fixture. FIG. 3a (prior art) shows an exemplary fixture lens divided into three concentric areas, each separately producing the colored light according to the RGB color space and according to a respectively applied command. In other words, such three areas are controlled independently by three respective physical parameters being (red1, red2, red3), or (green1, green2, green3) or (blue1, blue2, blue3).

FIG. 3b schematically illustrates how the fixture of FIG. 3a can be controlled by HSI and Red All, so as to obtain the red light from the virtual parameter HSI 5 and to make the red light be lit simultaneously at all the concentric areas of the lens.

Obtaining any “color” command from HSI is performed by a conversion function 26 in the individual interface 20, which is then spread into three software “branches” 21 of RGB color space for three respective areas of the lens. The three “branches” work in parallel and issue their corresponding commands for Red, Green and Blue in three respective time slots 23, 25, 27. That is the result of the conversion function 26a for the fixture 19, presented in values of physical parameters. Order of the obtained values in time is important for controlling different areas of the fixture 19. In case a virtual parameter Red All is activated, the conversion function 34a, adapted to the fixture 19, will extract data only from the slot 27 and they will be utilized in the prescribed order so that the three areas of the fixture 19 will simultaneously receive only the control sequences corresponding to the physical parameters red1, red2, red3. They may be sent to the fixture directly or via the block 28.

Actually, FIG. 3a schematically illustrates one kind of a combined conversion function developed by the Inventor for the individual interfaces like 20, according to the invention.

FIG. 4 is a simplified block diagram of an example of the system for lighting control, for example, in the form of a control console.

FIG. 4 schematically shows the control console 60 for controlling ten fixtures 50 (50.1 . . . to 50.10).

For each of the fixtures, an individual interface is created in the console for controlling the fixture by at least one virtual parameter. The individual interfaces (I/F) are marked as 20.1 to 20.10. Preferably, the interfaces 20.1-20.10 utilize a set of common virtual parameters which may be grouped in a central interface 62.

The central interface 62 shows some exemplary virtual parameters out of those which are used for controlling the fixtures: HSI, XYZ, Red all, Virtual Gobo. The central console may also comprise one or more physical parameters available for direct control, they are schematically shown as a box marked PP. Control inputs (exemplary ones are shown as arrows 76.1, 76.2, 76.3 and 76.4) are intended for controlling the respective virtual parameters by a user/a program. A control input 78 is symbolically shown as allowing control of physical parameters of the fixtures via schematic block PP of interface 62.

The system/console 60 further comprises a central processing unit CPU 64 with a memory block accommodating a group of data bases. The processing unit 64 is in communication with a graphic user interface GUI 70 which may be integral with the central interface 62 (schematically shown by the common border line there-between).

The console may optionally comprise an abstract control interface (say, in the form of Abstract Control Module) for converting physical parameters, obtained in the I/F 20.1-20.10, into control sequences. However, the ACM layer may be distributed between the individual interfaces and form part thereof (shown as 28.1 . . . 28.10), so that the respective control sequences are obtained at the I/F blocks 20.1-20.10.

The console also comprises a group of hardware-software playback blocks (all schematically shown in FIG. 4 as a combined box 74) for performing playback of lighting programs/records and allowing for possibilities to control the virtual parameters, change intensity, repeat the record, control pauses, etc.

The arrows of Control inputs 76.1-76.4 are shown as passing through the playback block 74, to indicate that the user may control the virtual parameters by affecting them at the playbacks.

The console 60 may be used for performing the following operations:
Preparing an inventory data base where specific physical parameters of a plurality of existing fixtures of a group of known manufacturers are registered (inventory DB 66), for example by downloading information from manufacturers or from other data sources;
Building a proprietary database (DB 68 of conversion functions), comprising a table of the virtual parameters having their respective values (say, from 0 to 100%), and a set of conversion functions in the form of corresponding rules or tables including mathematical expressions and/or coefficients for each specific parameter for each specific fixture, said expressions and/or coefficients interconnecting the virtual parameters with the specific real parameters of respective specific fixtures.

Based on the above, the console allows the manufacturer/a user to create:
Individual interfaces 20 for any new/replaced/repaired/fixture, and to adjust existing interfaces 20 to real conditions of the fixtures;
Programs of lighting control per fixture, in the form of files of values of the virtual parameters (HSI, etc.) for each and every fixture for a specific performance/show; the program files may be stored in the DB of show programs (72), and then be readily run on the individual interfaces (20.1-20.10) so as to be finally converted to values of specific physical parameters of any specific fixture and to the required control sequences,
Light effects by performing play-back of the stored programs on the play-back blocks 74, which control the individual interfaces and through them—the fixtures.

Adjustment of interfaces 20 to real conditions of the fixtures can be performed by regulating the virtual parameters via the control inputs (76.1-76.4), and by using a calibration block 79 (which is in communication with the interfaces 20.1-20.10 and with an external hardware unit, for example capable of measuring angles of the light beams). It should be noted that only some of functional connections and communication lines are shown in FIG. 4 and explicitly described.

These and some other operations will be described in more detail with the aid of FIG. 5.

FIG. 5a is a combined flow chart diagram of one practical version of the proposed method. All operations described below may be performed by the operator/user in front of the GUI 70 and in interaction there-with. The GUI is in communication with the CPU 64 supported by data bases 66, 68, 72, and they both are in communication with playbacks 74 (FIG. 4).

In the flow-chart:

Box 80 “Create and patch fixtures” means creating and collecting individual interfaces 20 for given fixtures.

The box 82 “program fixtures” means programming fixtures in terms of virtual parameters and/or physical parameters as well, using the options given by the console (see boxes of virtual parameters and box PP in the central interface 62 of FIG. 4).

The box 84 (“Store”) means storing the obtained programs in the DB 72 of show programs. The DB 72 may have libraries and lists of light effects. The programs from DB 72 may be then attached on playbacks (box 88 of the flow chart and the hardware-software units generally shown as block 74, which are provided in a console 60 of FIG. 4). If desired, data downloaded to the playbacks may be replaced with other preliminarily stored data.

FIG. 5b shows that for “creating the fixtures” (i.e., their I/F), the user has to:
import files from database 66 of the fixtures data (block 90);
Select the fixtures files suitable or at least similar to the available fixtures (block 92);
Compose the group of a number of selected fixtures (block 94);
Provide each I/F with the DMX address of the real fixture (block 96)
It actually means that all the conversion from physical parameters to control sequences can be done in the individual interfaces.

FIG. 5c shows that for programming the control of each specific fixture, the operator has to:
select and point out the fixtures to be programmed (box 100), by selecting the I/F using GUI 70; 10
select virtual and possibly also physical parameters to be programmed; box 102;
thereupon, the user may assign/change values to the desired virtual and/or physical parameters for controlling the fixtures (box 104);
Alternatively or in addition, the user may create some light effect (box 106) on one or more parameters, including the virtual parameters. Effect is usually based on applying a function to the parameter so as to change its value in time. The programmed effect may be then stored (see FIG. 5d).

FIG. 5d shows that the programmed file can be stored as a kind of light state/effect record (Cue, box 110) and further stored in a list of records (Qlist, box 112).

The programmed record may be stored in a library of light effects (box 114), for example within the DB 72.

FIG. 5e shows that for checking/implementing the effect, the programmed portions/records of light performance may be
selected/called from the library in Database 72, for example from a Qlist comprising a number of records, (box 120), and then
attached to playbacks (box 122 in the flow chart of FIG. 5e; block 74 in FIG. 4) for implementing the lighting records.
Control of virtual parameters (as well as control of physical parameters, if required) can be performed via the playbacks.

It should be appreciated that though the invention has been described using specific examples, other versions of the method and other embodiments of the system may be proposed and should be considered part of the invention, whenever defined by the claims which follow.

1. A method for lighting control, comprising
assigning to a specific fixture at least one virtual parameter convertible into one or more physical parameters of the fixture, for controlling the fixture by controlling said at least one virtual parameter.

2. The method according to claim 1, wherein the at least one virtual parameter comprises at least one of the following:
a phantom parameter not existing among physical parameters of any fixture;
a physical parameter not existing among physical parameters of said specific fixture, while existing among physical parameters of a different fixture.

3. The method according to claim 2, wherein the phantom parameter is selected from the following non-exhaustive list:
“HSI” being Hue, Saturation, Intensity;
“X,Y,Z” being coordinates of the fixture's “hit point”,
“Red all”, “Green all”, “Blue all”,
“Cyan all”, “Magenta all”, “Yellow all”,
“Virtual Gobo”.

4. The method according to claim 1, further comprising controlling said fixture by controlling said at least one virtual parameter.

5. The method according to claim 4, comprising controlling said at least one virtual parameter in real time.

6. The method according claim 1, for controlling a group of fixtures including at least one said fixture.

7. The method according to claim 6, comprising providing individual interfaces for respective fixtures of the group, wherein each of the individual interfaces
allows controlling said at least one virtual parameter, and
provides one or more conversion functions for converting values of said at least one virtual parameter into values of physical parameters of the corresponding fixture,
thereby enabling control of the physical parameters of said group of fixtures by said at least one virtual parameter.

8. The method according to claim 7, wherein
each specific fixture of the group has a basic set of physical parameters allotted by the manufacturer of the specific fixture,
and wherein the step of providing the individual interfaces comprises representing each specific fixture of said group by an individual interface (I/F) enabling control of a combined set of parameters, wherein said combined set for a specific fixture includes:
the basic set of physical parameters of the specific fixture,
an additional set including said at least one virtual parameter, along with respective one or more conversion functions, for converting each of the at least one virtual parameters into one or more physical parameters of the specific fixture,
the method thereby ensuring that each of said individual interfaces is capable of receiving control instructions to said at least one virtual parameter, converting said control instructions into control commands to one or more of said physical parameters of the individual interface, for further controlling the corresponding fixture using said control commands.

9. The method according to claim 7, enabling control of said group of fixtures by translating the values of physical parameters of said fixtures into suitable control sequences.

10. The method according to claim 7, further comprising a step of adjusting the individual interfaces to current conditions and location of their corresponding fixtures.

11. The method according to claim 7, wherein at least one of the conversion functions of the individual interface is additionally provided with a capability to forward values of the physical parameters to relevant elements of the specific fixture in a predetermined order in space and time.

12. The method according to claim 3, wherein the Virtual Gobo parameter is presented by a data base comprising a plurality of gobo patterns and being categorized so as to enable selection of a virtual gobo pattern from it, and wherein the respective conversion function in the individual interface of a specific fixture being adapted to convert the selected gobo pattern into the closest gobo pattern allotted in the specific fixture.

13. The method according to claim 8, comprising providing all fixtures of the group with a unified combined set of parameters, so that to enable controlling all said fixtures by affecting similar common parameters of the unified combined set.

14. The method according to claim 1, further comprising performing light effects on at least one said fixture, by programming said light effects based on control of the at least one virtual parameter of said at least one fixture.

15. The method according to claim 14 further comprising creating a library of the light effects written down in values of said at least one virtual parameter.

16. The method according to claim 7, further including a calibration step for checking values of said at least one virtual parameter, so as to adjust thereof to physical parameters of the corresponding specific fixture.

17. A system for implementing the method according to claim 1.

18. A system for controlling a group of fixtures including at least one fixture,
the system comprises one or more control inputs for controlling one or more virtual parameters of at least one of said fixtures by a user and/or a program.

19. The system according to claim 18, further comprising
a central processing unit and data bases suitable for forming and further using individual interfaces of the fixtures, each of said individual interfaces providing at least one controllable virtual parameter, wherein said individual interfaces being controlled by said control inputs and controlling said fixtures.

20. A software product comprising computer implementable instructions and/or data for carrying out the method according to claim 1, said software product being stored on an appropriate computer readable storage medium so that the software is capable of enabling one or more operations of said method when used in a computerized system.
